(19) United States
(12) Patent Application Publication
(10) Pub. No.: US 2025/0104357 A1
(43) Pub. Date: Mar. 27, 2025

(54) SYSTEM FOR PROVIDING VIRTUAL WORLD SERVICE AND METHOD THEREOF

(71) Applicant: SAMSUNG ELECTRONICS CO., LTD., Suwon-si (KR)

(72) Inventor: Michal WODCZAK, Suwon-si (KR)

(73) Assignee: SAMSUNG ELECTRONICS CO., LTD., Suwon-si (KR)

(21) Appl. No.: 18/900,162

(22) Filed: Sep. 27, 2024

(30) Foreign Application Priority Data
Sep. 27, 2023 (KR) 10-2023-0130843
Nov. 2, 2023 (KR) 10-2023-0150253

(51) Int. Cl. G06T 17/20; G06T 13/40

(52) U.S. Cl. CPC G06T 17/20; G06T 13/40

(57) ABSTRACT

A method of providing a virtual world service, includes: receiving, by a service-based architecture (SBA), a first registration request from a user equipment (UE); receiving, by the SBA, a second registration request for a virtual object related to the UE through a virtual application function (VAF) in a virtual world, based on whether the first registration request is allowed; acquiring parameters for the UE, the virtual object, and the virtual world by an artificial intelligence function (AIF); and providing a virtual mesh function (VMF) with information configured for the virtual world by the AIF.

### CROSS-REFERENCE TO RELATED APPLICATIONS

This application claims priority to Korean Patent Application Nos. 10-2023-0130843 and 10-2023-0150253, filed on Sep. 27, 2023, and Nov. 2, 2023, respectively, in the Korean Intellectual Property Office, the disclosures of which are herein incorporated by reference in its entirety.

### BACKGROUND

### 1. Field

Various embodiments of the disclosure relate to a system for providing a virtual world service and a method thereof.

### 2. Description of Related Art

With the development of technology, various services such as a metaverse that provides virtual space services by integrating virtual reality, augmented reality, and three dimensional (3D) virtual environments through various electronic devices and a network system in a digital environment (where the real world and the virtual world are combined) are becoming a reality.

The information may be provided as the related art to help understanding of the disclosure. Any opinion or decision on whether the above-mentioned content can be applied as the prior art related to the disclosure has been not provided.

The above information is presented as background information only to assist with an understanding of the disclosure. No determination has been made, and no assertion is made, as to whether any of the above might be applicable as prior art with regard to the disclosure.

### SUMMARY

According to an aspect of the disclosure, a method of providing a virtual world service, includes: receiving, by a service-based architecture (SBA), a first registration request from a user equipment (UE); receiving, by the SBA, a second registration request for a virtual object related to the UE through a virtual application function (VAF) in a virtual world, based on whether the first registration request is allowed; acquiring parameters for the UE, the virtual object, and the virtual world by an artificial intelligence function (AIF); and providing a virtual mesh function (VMF) with information configured for the virtual world by the AIF.

According to an aspect of the disclosure, a system for providing a virtual world service, includes: a service-based architecture (SBA) configured to receive a first registration request from a user equipment (UE); a virtual application function (VAF) configured to transmit a second registration request for a virtual object related to the UE from the UE to the SBA in a virtual world, based on whether the first registration request is allowed; an artificial intelligence function (AIF) configured to acquire parameters for the UE, the virtual object, and the virtual world; and a virtual mesh function (VMF) configured to receive information configured for the virtual world by the AIF.

The technical problem to be solved in the disclosure, and technical features and effects to be achieved by disclosure may not be limited to the above mentioned technical problem, technical features, and effects, and other technical problems, technical features, and effects which are not mentioned may be clearly understood, through the following descriptions, by those skilled in the art of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device within a network environment according to various embodiments;

FIG. 2 illustrates an example of a metaverse architecture according to an embodiment;

FIG. 3 illustrates a network system for providing a virtual world service according to an embodiment;

FIGS. 4, 5, and 6 illustrate examples of a Trino architecture according to an embodiment;

FIG. 7 illustrates an example of fifth generation (5G) system architecture according to an embodiment;

FIG. 8 illustrates a 5G system and an example of a multi-access edge computing group (MEC) function according to an embodiment;

FIG. 9 illustrates an example of an MEC application according to an embodiment;

FIGS. 10 and 11 illustrate an example of a system for providing a virtual world service and a method thereof according to an embodiment;

FIGS. 12 and 13 illustrate an example of a system for providing a virtual world service and a method thereof according to an embodiment;

FIGS. 14 and 15 illustrate an example of a system for providing a virtual world service and a method thereof according to an embodiment;

FIGS. 16 and 17 illustrate an example of a system for providing a virtual world service and a method thereof according to an embodiment;

FIGS. 18 and 19 illustrate an example of a system for providing a virtual world service and a method thereof according to an embodiment;

FIGS. 20 and 21 illustrate an example of a system for providing a virtual world service and a method thereof according to an embodiment;

FIGS. 22 and 23 illustrate an example of a system for providing a virtual world service and a method thereof according to an embodiment;

FIGS. 24 and 25 illustrate an example of a system for providing a virtual world service and a method thereof according to an embodiment; and

FIGS. 26 and 27 illustrate an example of a system for providing a virtual world service and a method thereof according to an embodiment.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

Before undertaking the detailed description below, it may be advantageous to set forth definitions of certain words and phrases used throughout the disclosure. The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

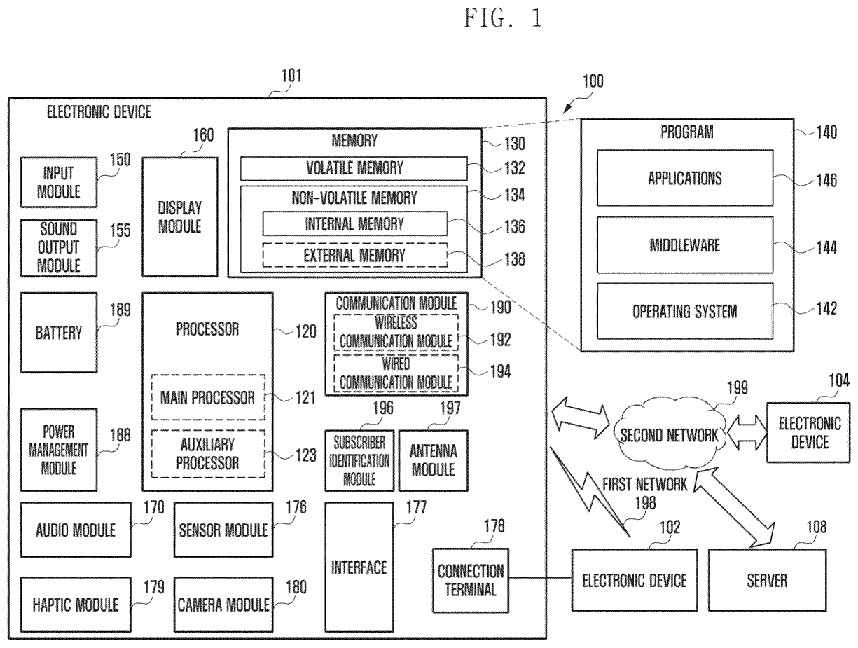

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

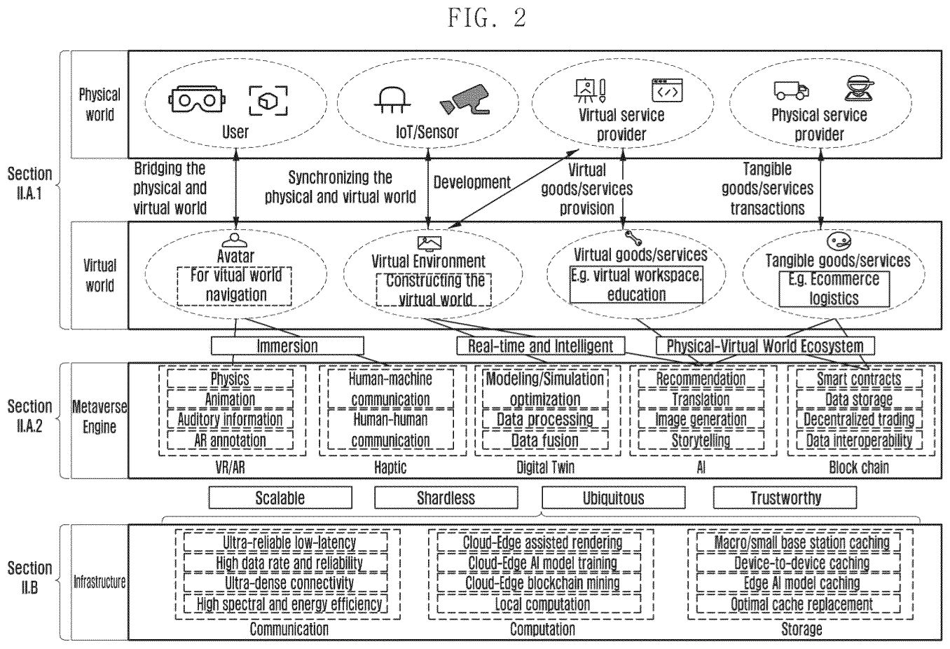

FIG. 2 illustrates an example of a metaverse architecture according to an embodiment.

According to an embodiment, the metaverse architecture that is an example of the virtual world service may include various technologies and systems for providing an environment for convergence of a virtual or extended physical world and a physical world. The virtual world exists in parallel with a physical world and means a space where users virtually explore and interact.

The virtual world service may be realized through various functions such as a metaverse engine that implements various technologies, based on various platforms and infrastructure of the physical world (for example, metaverse edge infrastructure). The virtual world service may be realized through, for example, various virtual products or services provided to avatars acting according to a user's intention. For example, the virtual world service may be realized through a combination of various technologies such as virtual reality (VR), augmented reality (AR), blockchain, haptic, digital twin, cloud computing, and artificial intelligence (AI).

In the physical world, a user may experience a virtual world through supporting of a service by a virtual service provider or a reality service provider through various peripheral devices (for example, the electronic device 102 of FIG. 1) such as an IoT device, a VR headset, and a smart watch including a client application and various sensors installed in the electronic device (for example, the electronic device 101 of FIG. 1) such as a smartphone, a notebook, or a PC.

The virtual reality technology or the augmented reality technology (VR/AR) may allow the user to project virtual objects into the physical world to experience the virtual world that is implemented in parallel with the physical world. As virtual elements are added to the physical world, interaction may increase and the user's vision and hearing are connected to the virtual world and the physical world and the virtual world may converge, and thus the user can be immersed in the virtual world.

A large-scale metaverse environment needs many calculation and storage capacities and allows users to access the metaverse through a high-capability server through cloud computing, thereby meeting the requirements.

The blockchain technology may be used to protect assets and ownership by recording ownership of digital assets and allowing transactions to be tracked in the virtual world. Further, the blockchain technology may implement strong security systems and privacy policies in order to protect user data and private information in the virtual world.

The artificial intelligence and natural language processing technology may be used to increase reality of the virtual world and improve interaction by detecting and reacting to the user's action and voice and allowing the user to talk to virtual characters.

A user interface and an experience design in the virtual world are intuitive and allow the user to more conveniently interact in the virtual world through a user friendly interface and design.

Metaverse edge infrastructure is important technology and infrastructure to realize and support the metaverse environment and may include distributed network technology, delay time reduction technology, and content caching and streaming technology.

The metaverse edge infrastructure may allow the user to access and interact with the metaverse anywhere in the world, based on the distributed network structure, and may minimize the delay time for real-time interaction, efficiently cache and stream content in order to optimize data flow such as large 3D models, texture, and videos, interact with the user by using AI technology, and control operations of characters and objects within the virtual world.

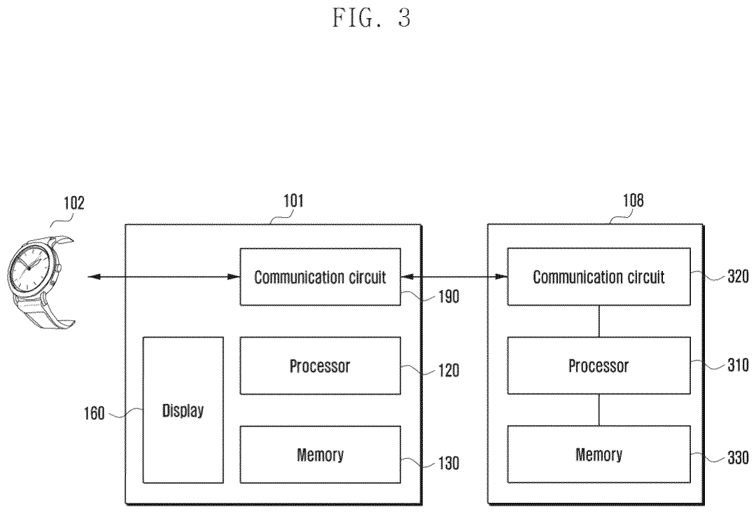

FIG. 3 illustrates a network system for providing a virtual world service according to an embodiment. According to an embodiment, the network system may include one or more client electronic devices (for example, the electronic device 101 of FIG. 1), one or more external electronic devices (for example, the electronic device 102 of FIG. 1), one or more servers (for example, the electronic device 108 of FIG. 1), and a network (for example, the first network 198 or the second network 199 of FIG. 1). Hereinafter, although the metaverse is described as an example of the virtual world, embodiments are not limited thereto, and the virtual world is not limited by any name other than the metaverse and may include various virtual worlds having various concepts.

According to an embodiment, the electronic device 101 may include a computing device such as a PC, a notebook, or a smartphone. The electronic device 101 may be connected to external electronic devices (for example, the electronic device 102 of FIG. 1) such as a head-mounted display, a smart watch, or various sensors and may access the server 108 through the network.

According to an embodiment, one or more servers 108 may host a virtual world or the metaverse simulated for a plurality of client electronic devices 101.

The electronic device 101 may include a communication circuit (for example, the communication module 190 of FIG. 1) for communicating with the external electronic device 102 or the server 108, a processor (for example, the processor 120 of FIG. 1), a memory (for example, the memory 130 of FIG. 1), and a display (for example, the display module 160 of FIG. 1).

According to an embodiment, the processor 120 may load and execute a metaverse application stored in the memory 130 as a computer-readable command, process a metaverse application command, and store relevant data packets in the memory 130 according to the execution of the metaverse application or transmit and receive the data packets through the communication module 190. The elements of the electronic device 101 in FIG. 3 are only examples and may further include various elements illustrated in FIG. 1.

The metaverse application may include, for example, a client application for allowing the electronic device 101 to operate as a client of a metaverse service provided by the server 108. Through the client program, the electronic device 101 may allow the user to interact with other users of other client electronic devices connected to the server 108. For example, the client program may include a group link interface for allowing the user to control or configure a group link connection and interact within a metaverse virtual world as a part of the group link connection.

According to an embodiment, the electronic device 101 may three-dimensionally or four-dimensionally display a visual expression of the virtual world through various display devices including the display module 160.

According to an embodiment, the electronic device 101 may acquire various pieces of data from the external electronic devices 102 such as the connected head-mounted display, the smart watch, or various sensors. For example, the data acquired from the external electronic devices 102 may include, for example, breath, blood pressure, heartbeat, and/or body position and activity-related data measured based on signals acquired through, for example, a biometric sensor and an acceleration sensor (for example, the sensor module 176 of FIG. 1). For example, the smart watch may acquire various pieces of data such as motion data including an electrocardiogram (ECG), a heartbeat, a blood oxygen level, and motion data including a movement speed and direction and transmit the same to the electronic device 101.

According to an embodiment, the electronic device 101 may provide data of the real world acquired from the external electronic device 102 to the virtual world such as a metaverse through the server 108, receive data from the virtual world, and synchronize the real world data and the virtual world data.

According to an embodiment, the server 108 may include a processor 310 (for example, the processor 120 of FIG. 1), a communication circuit 320 (for example, the communication module 190 of FIG. 1), and a memory 330 (for example, the memory 130 of FIG. 1).

The server 108 may realize a virtual world which users of one or more electronic devices 101 participate in and interact with each other through a metaverse application stored in the memory 330 as a computer-readable command. For example, the server 108 may allow various users to interact with each other through objects or avatars indicating themselves in the virtual world or perform various activities such as purchasing virtual or real products or services.

The server 108 may collect and analyze data through artificial intelligence (AI) to identify anomalous data and predict and modify problems to avoid the network performance from deteriorating or stopping, thereby optimizing the virtual world service. The server 108 may be connected to an advertisement server to provide an advertisement service through the virtual world and search for and provide a relevant advertisement campaign, based on user activities analyzed through AI. For example, the advertisement server may provide information including advertisement campaign resources and advertisement metadata to the server 108 and thus a real-time interactive advertisement can be provided to the virtual world.

According to an embodiment, the electronic device 101 may transmit and receive data of the real world and the virtual world to synchronize the data in order to identify attempts at cheating through the server 108 in the metaverse virtual world, and the server 108 may analyze data to predict problems that may occur in the virtual world in order to avoid the problems that may occur or take a proper response through a relevant resilience engine and perform a resilience control operation according thereto.

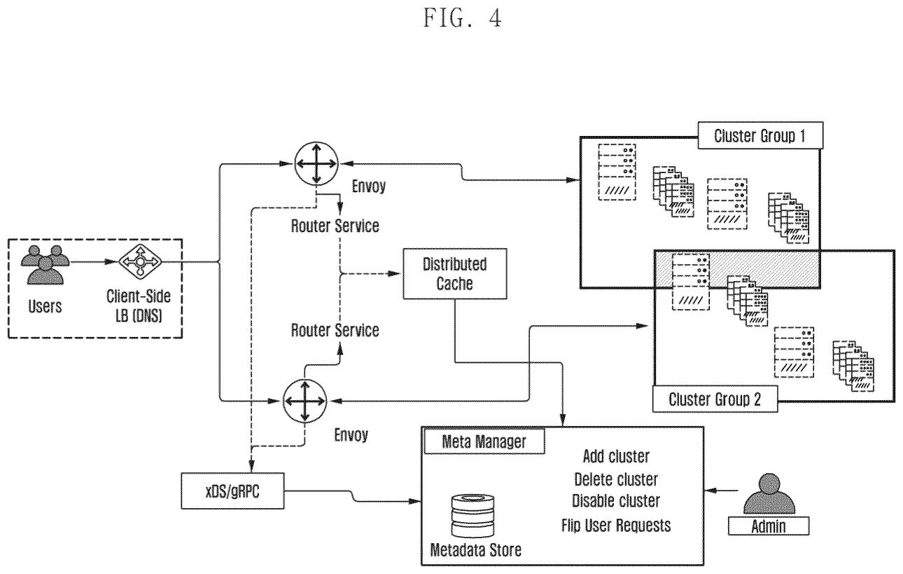

FIGS. 4, 5, and 6 illustrate examples of a Trino architecture according to an embodiment.

Referring to FIG. 4, the Trino architecture may integrate internal authentication, authorization, data catalog, and monitoring systems through a plurality of clusters. The Trino architecture may support a data source through a cloud and monitoring system and configure a connection with a Hadoop distributed file system (HDFS) through a Hive connector.

The user may be connected to Trino through various clients such as CLI, JupyterHub, a SQL editor, custom reporting tools, and a JDBC-based app. When the user executes a query, the query may be transmitted to a client load balancer (DNS-based load balancer), and the load balancer may route the query to a lower envoy router. The router may perform syntax analysis on a query header, determine a user of the corresponding query, and determine a cluster group to which the query is routed based on the user. When the query arrives at a cluster group, the query may be allocated to one of lower cluster of the corresponding cluster group. For example, when the user executes the query, the query may be routed to cluster group 2 and routed again to one of the lower clusters according to a routing rule. Envoy is an open source edge and service proxy designed for a cloud native application and may provide functions such as routing, traffic management, load balancing, external authorization, and speed limit. The Envoy proxy may be used as a Trino gateway, and allow the outside to achieve dynamic routing without any change in the default operation of Trino. A metadata service may provide the envoy router with a cluster group, a cluster group and lower clusters, and a cluster-related configuration including cluster group mapping to the user.

An envoy control plane is an xDs gRPC-based service and, when the Envoy starts, may inquire about an xDS API to dynamically fetch an upstream cluster configuration, and periodically poll a metadata service to find a change in the cluster configuration. The Envoy may provide an HTTP filter that may perform syntax analysis and modification for all of the request and response headers, and call a router service of performing syntax analysis for a request through a user-specific Lua filter and extracting an x-trino-user header to return an upstream cluster address.

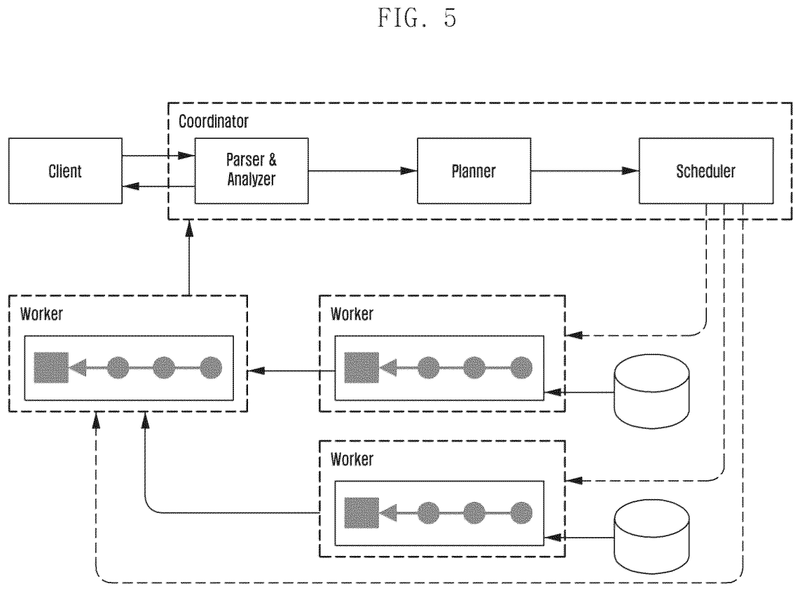

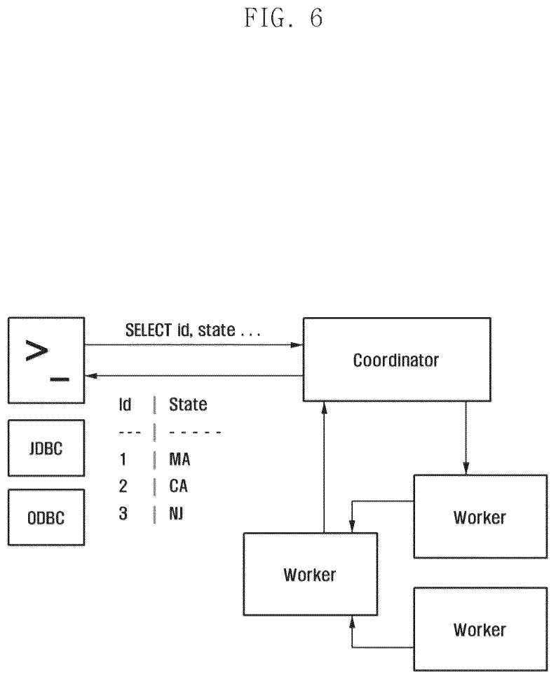

Referring to FIGS. 5 and 6, Trino is a distributed SQL query engine similar to massively parallel processing (MPP) and may perform distributed processing through a plurality of server clusters in a parallel manner. Through the Trino architecture, the Trino query engine may process an SQL and process an SQL query for a large amount of data in parallel through a computer or a node cluster.

A Trino cluster may include one coordinator and a plurality of operator nodes. A Trino user may be connected to a coordinator through a tool such as a client using a JDBC driver or a Trino CLI, and the coordinator may access a data source through operators.

The coordinator is a Trino server that processes inflowing queries and manages operators to execute queries, and the operator is a Trino server that executes tasks and processes data. The coordinator may execute a discovery service to register the operator in the cluster.

Communication and data transmission between the client, the coordinator, and the operator may use REST-based interaction through HTTP/HTTPS.

The coordinator may communicate with the operator and the client through an HTTP-based protocol. In the cluster, the coordinator may communicate with operators to allocate tasks, update states, and acquire the top result set to be returned to the user. Operators may communicate with other operators to receive data and search for a result set from a data source.

The Trino coordinator may receive an SQL and perform syntactic parsing and analysis (parser and analyzer) for a user's query, query plan (planner), and operator node reservation (scheduler). The user may interact with the coordinate through an application driver using a Trino CLI, JDBC, or ODBC, or another client library that can be used for various languages. In query syntax, data may be processed by the operator through a task connected to the cluster and a processing result may be provided to the coordinator and provided to the client through an output buffer. When the output buffer is read by the client, the coordinator may send a request for a larger amount of data to the operator on behalf of the client, and the operator may interact with the data source again to fetch the data. The data may be continuously requested by the client until query execution is completed and may be provided from the data source by the operator.

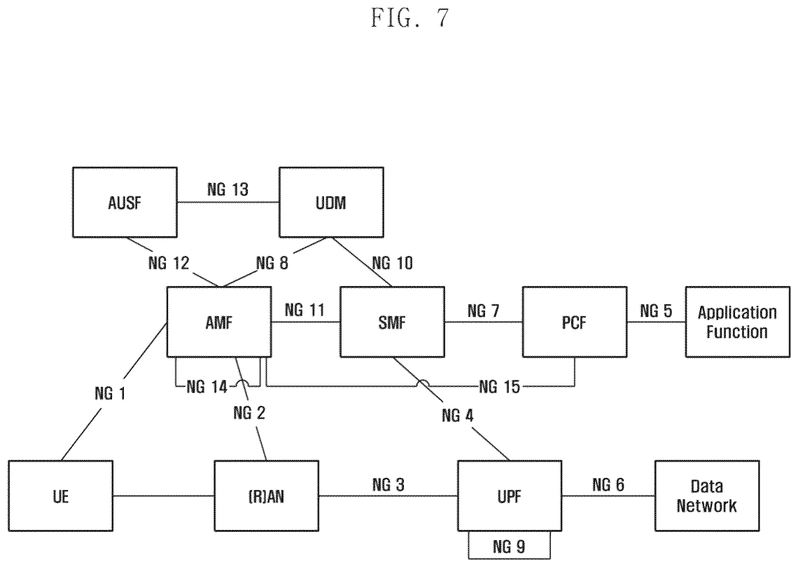

FIG. 7 illustrates an example of a 5G system architecture according to an embodiment.

Referring to FIG. 7, in the 5G system architecture, network functions (NFs) may be implemented as network elements of dedicated hardware, software instances executed by dedicated hardware, or instantiated and virtualized functions in a platform such as cloud infrastructure.

An access and mobility management function (AMF) that is one of the network functions may provide UE-based authentication, authorization, and mobility management. Since the AMF is independent from access technology, a UE using multiple access technology may be basically connected to a single AMF. A session management function (SMF) may serve to perform session management, allocate an IP address to the UE and select and control a user plane function (UPF) for data transmission. When the UE has a plurality of sessions, different SMFs may be allocated to respective sessions to individually manage the sessions and may provide different functions to respective sessions. An application function (AF) may provide information on packet flow for a policy control function (PCF) that serves to control a policy in order to support quality of service (QoS). The PCF may determine a policy for mobility and session management to allow the AMF and the SMF to properly operate based on the information. While an authentication server function (AUSF) stores data for authenticating the UE, user data management (UDM) stores subscription data of the UE. A data network, not a part of the 5G core network, may provide Internet access or operator service.

A reference point of the 5G system architecture may indicate call flow between NFs. Next generation (NG) 1 may be defined to transmit signaling between the UE and the AMF. Reference points for connecting the AN and the AMF, and the AN and the UPF may be defined as NG2 and NG3, respectively. There is no reference point between the AN and the SMF, but there is a reference point NG11 between the AMF and the SMF. Accordingly, the SMF may be controlled by the AMF. Since NG4 is used by the SMF and the UPF, the UPF may be configured using a control signal generated by the SMF and may report its own state to the SMF. NG9 is a reference point for the connection between different UPFs, and NG14 is a reference point for the connection between different AMFs. NG15 and NG7 may be defined to apply policies to the AMF and the SMF by the PCF. NG12 may be needed to authenticate the UE by the AMF. NG8 and NG10 may need and define subscription data of the UE for the AMF and the SMF.

In the 5G system architecture, a control plane and a user plane are separated, and the user plane may transmit user traffic and the control plane may transmit a signal in the network. For example, the UPF may be in the user plane, and all of the other NFs, that is, the AMF, the SMF, the PCF, the AF, the AUSF, and the UDM are in the control plane. When the user plane and the control plane are separated, the size of each plane resource may be independently controlled. The UPF may be distributed separately from a control plane function in a distributed manner. The UPF may be disposed close to the UE in order to reduce a round trip time (RTT) between the UE and a data network for some applications that need latency.

The 5G system architecture may include modularized functions. For example, the AMF and the SMF are independent functions in the control plane, and the separated AMF and SMF can independently evolve and expand. Through modularized function design, the 5G system architecture may flexibly support various services.

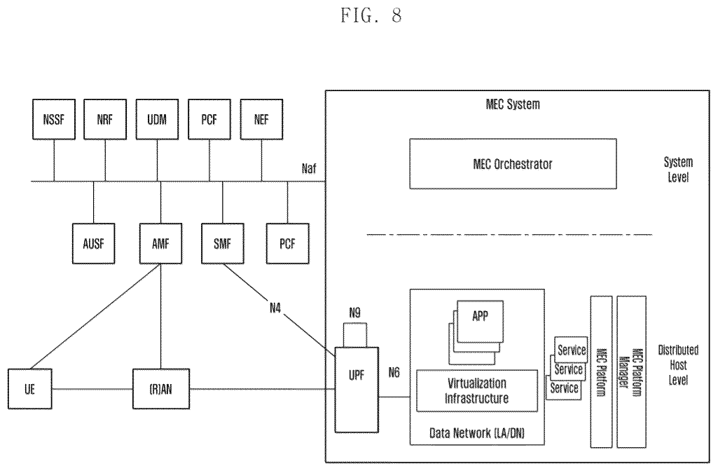

FIG. 8 illustrates a 5G system and an example of a multi-access edge computing group (MEC) function according to an embodiment.

Edge computing is the developed form of cloud computing, and may move application program hosting from a centralized data center to a network edge, so as to make the application program hosting closer to data generated by the application program. Edge computing may support a communication network that has a short waiting time, increases bandwidth efficiency, and changes to a multi-purpose service platform.

In order to manage an app service and control orchestration and specific traffic flow by placing the MEC in the 5G and connecting the same with a user plane, interaction with a data plane may be performed.

The 5G system architecture and the 5G system architecture defined in the MEC 3GPP are designed to support various usage examples ranging from a plurality of IoT devices to a high-bandwidth and high-reliability mission critical service. The 5G system architecture may include an option using a reference point and an interface approach and an option in which a core network function uses a service-based architecture (SBA) and interact therewith.

According to the SBA, there are a function using a service and a function generating a service, and a network function may provide one or more services. The SBA may provide functions of registration, service search, availability notification, deregistration, authentication, and approval required for authenticating a user, approving a service request, and efficiently providing a service.

Referring to FIG. 8, a 3GPP 5G system and SBA thereof on the left side and a MEC system architecture on the right side may be integrated and arranged. Entities of the MEC may interact with network functions (NFs) of the 5G core network.

Network functions and services generated thereby may be registered in a network resource function (NRF), and a service generated by an MEC application may be registered in a service registry of the MEC platform. Service registration may be a part of application activation functions, and when authorized to use the service, the network function may directly interact with the network function that generates the service. A list of available services may be found by the NRF, some services may be accessed only through the NEF, and the NEF may allow even untrusted entities outside the domain to access the service. The NEF may serve as a central point of service exposure and play a key role in approving all access requests made outside the system.

In the 5G, necessary functions in the available network functions and resources may be allocated to different services or tenants using the services through network slicing. A network slice selection function (NSSF) may select a network slice instance suitable for the user and allocate a necessary access management function (AMF). The MEC application, that is, an application hosted to a distributed cloud of the MEC system may be included in one or more network slices included in the 5G core network.

The policy and rule of the 5G system may be processed by a policy control function (PCF). The PCF is a function that serves to perform a service requested by the AF (for example, the MEC platform) to influence the traffic streaming rule, and may perform direct access or access through the NEF and vary depending on whether it is reliably by the AF or whether the corresponding PDU session is known at a requested time point in the case of traffic streaming.

A integrated data management (UDM) function may serve to perform various services related to the user and the subscriber, and may generate 3GPP AKA credential, process user identification-related information, approve access (for example, roaming restriction), register user service NFs (a serving AMF and the SMF), record SMF/data network naming (DNN) allocation histories to support service continuity, and serve as a contact point for supporting a legal interception (LI) procedure in external roaming, so as to perform a subscriber management procedure.

The user plane function (UPF) may play a key role in integrated MEC arrangement in the 5G network. From a viewpoint of the MEC system, the UPF may be a distributed and configurable data plane, and the control of the data plane, that is, the traffic rule configuration may follow a route of NEF-PCF-SMF. Accordingly, in specific arrangement, a local UPF may be implemented as a part of MEC implementation.

In the MEC system on the right side of FIG. 8, an MEC orchestrator is a function entity at an MEC system level and may operate as the AF and interact with target 5G NFs through the network exposure function (NEF) or directly. At an MEC host level, the MEC platform may interact with 5G NFs as the AF. The MEC host, that is, a function entity at the host level is mostly disposed in the data network of the 5G system, and the NEF is a core network function and is disposed in the center in conjunction with similar NFs as a system level entity, but an instance of the NEF may be disposed at the edge in order to allow access of a low-latency and high-throughput of the MEC host.

User movement management is an important function in the mobile communication system, and may end a RAN control plane and non-access stratum (NAS) procedure through an access and mobility management function (AMF) that processes a movement-related procedure, protect signal integrity, and interface with a legal interception function for registration, connection, access management, access, and movement event, authenticate and approve an access layer, and host a security anchor function (SEAF) in the 5G system. Through the SBA, the AMF may provide communication and access services to other NFs and allow subscription to receive notifications of mobility events.

The session management function (SMF) may perform a procedure such as session management, IP address allocation and management, dynamic host configuration protocol (DHCP) service, UPF selection/reselection and control, UPF traffic rule configuration, legal interception of session management events, charging, and roaming support. Since the MEC service can be provided by the central and edge clouds, the SMF may serve to select and control the UPF and configure the rule for traffic streaming, and perform services required for managing a PDU session, controlling a policy configuration and the traffic rule, and subscribing to notifications of session management events.

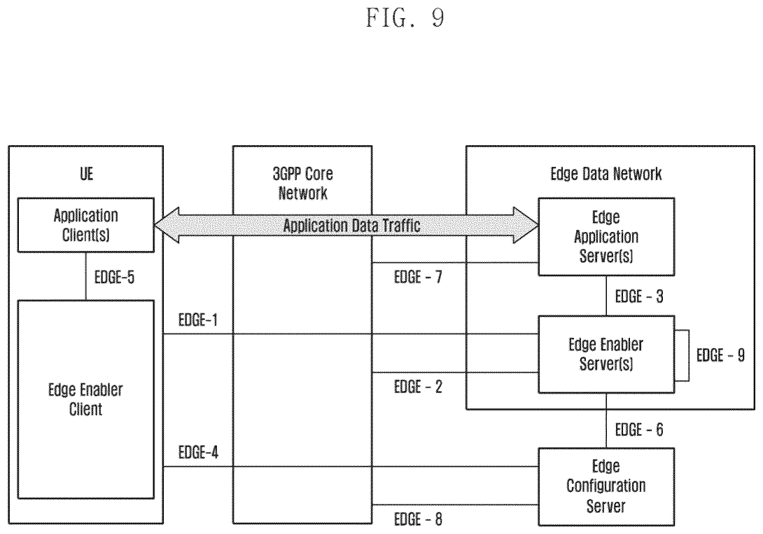

FIG. 9 illustrates an example of an MEC application according to an embodiment.

Referring to FIG. 9, a 3GPP core network may define a function layer that relays communication for edge computing. The function layer may relay communication between an application client (AC) or an app executed in the UE and an edge application server (EAS) disposed in an MEC data network.

The function layer that facilitates communication between the application client (AC) executed in the UE and the edge application server (EAS) distributed to the edge data network may be defined. The function layer may include functions related to service provisioning and EAS search, and provide application program context transmission between EASs, service activation for the EAS, and supporting services such as a function exposure API for service continuity.

An application program architecture for activating the edge application may include the following elements. An edge enabler client (EEC) may provide ACs with supporting functions such as the EAS search and provide ACs within the UE with supporting functions. An edge configuration server (ECS) may provide configuration information such that the EEC is connected to the EAS.

The application program client of the UE may be edge-aware or edge-unaware. In the case of the edge-aware application, ACs may directly interact with the EEC and use all advantages of an SA6 architecture. In the case of the edge-unaware application, the SA6 architecture may provide important advantages on behalf of ACs without direct participation of the ACs. SA2 is working on edge application support solutions (for example, using the DNS for IP routing to the EAS), and may be distributed independently or in conjunction with the SA6 architecture.

Through supporting of the support layer, the 3GPP network may provide native supporting for various edge functions below. For example, a query filter for allowing on-demand service provisioning by the ECS and EAS's rich search by the AC through the EEC may be supported, and the EAS function can be changed for various reasons such as an arrangement change, UE movement, and the like due to flexible characteristics and availability of the edge network. The UE may control the service provided to the AC by subscribing to such a dynamic change. The EAS may use a service API exposed by the EES, and the API may be constructed based on capability of an SCEF/NEF northbound API and may be used in conjunction with or independently from CAPIF framework. Accordingly, the EAS may access a 3GPP network capability exposure function. Due to movement of the UE, the serving edge or cloud may change or become more suitable for serving the AC.

Meanwhile, the 3GPP mobile network may interwork with various heterogeneous networks such as an untrusted WLAN. Access of the UE to the 4G/5G or 3GPP network in the untrusted WLAN may be provided through a wireless access gateway (WAG) and a packet data gateway (PDG). The PDG may include a tunnel termination gateway (TTG) function. The UE accessing the 5GCN through the untrusted WLAN should support a NAS signal and may operate similar to 3GPP access that registers the UE by using the AMF during a registration and authentication procedure and uses EAP-AKA/5G-AKA authentication by using the AUSF. In order to safely protect a NAS mobility and session management message before the registration procedure ends, IPsec security association (SA) may be configured between the UE and the PDG. The UE may establish a PDU session by using a NAS session management message and IPsec signaling SA through the SMF and the AMF. Transmission of UL and DL packets between the UE and the data network may use the IPsec tunnel between the UE and the PDG.

Hereinafter, based on 5G or beyond 5G (B5G), SBA, and MEC, a system for providing a virtual world service and a method of performing the virtual world service will be described.

The system for providing the virtual world service according to an embodiment may include an electronic device (for example, the electronic device 101 of FIG. 1 or 3) connected to an external electronic device (for example, the electronic device 102 of FIG. 1 or 3) and a server (for example, the server 108 of FIGS. 1 and 3) connected to the electronic device 101.

According to an embodiment, the system for providing the virtual world service may perform various functions or operations through various NFs in order to provide the virtual world service, based on 5G or beyond 5G (B5G), SBA, and the MEC architecture.

According to an embodiment, based on the SBA, a virtual object such as an avatar (AV) may be connected with a virtual avatar function (VSF) and registered through a virtual subscriber function (VSF).

According to an embodiment, it is possible to perform registration through the mAMF by similarly corresponding to the xNB of the RAN.

According to an embodiment, a resilience engine function (REF) may be provided to fetch parameters and/or control resilience within the SBA or the MEC.

According to an embodiment, the virtual subscriber function (VSF) may register an avatar (AV) on behalf of the user equipment (UE) through the virtual avatar function (VAF). In the MEC, the VAF may register the AV on behalf of the UE in the RAN. The resilience engine function (REF) may automatically fetch parameters of the UE and the AV and control resilience through the VAF. Modified user data management (mUDM) may register tandem including the UE and the AV corresponding thereto. The modified authentication server function (mAUSF) may perform an authentication process for the AV on behalf of the UE. The modified access and mobility management function (mAMF) may load the parameter of the UE and make authentication of the AV possible. The modified user plane function (mUPF) may perform AV registration through a data plane/user plane (DP/UP) and translation between the DP/UP and a control plane (CP). The modified network exposure function (mNEF) may perform internal exposure and fetch parameters.

The parameter of the UE may include various pieces of information used for registering the AV on behalf of the UE and determining the parameter of the AV, for example, information related to the UE or a user of the UE acquired through various peripheral devices (for example, the electronic device 102 of FIG. 1) such as an IoT device, a VR headset, and a smart watch including client applications installed in an electronic device (for example, the electronic device 101 of FIG. 1), such as a smartphone, a notebook, or a PC, and various sensors. The parameter of the UE may include, for example, user's body information, biometric information, surrounding environment information, and/or motion information. The parameter of the AV may include various pieces of information generated according to registration and/or activities on behalf of the UE, based on the parameter of the UE, in the virtual world. The parameter of the AV may include, for example, appearance information of the AV, surrounding environment information, and/or motion information in the virtual world.

According to an embodiment, various services such as a service change in the virtual world or a change in the environment around the AV in the virtual world may be provided in response to an AV parameter change in the virtual world or a UE parameter change according thereto. For example, the UE and/or AV parameter change (for example, a heart rate change and/or AV motion) may be identified in response to an advertisement provided in the virtual world, and a customized service of changing at least one attribute of the environment around the AV may be provided as the feedback thereof. For example, the UE and/or AV parameter (for example, a heart rate change and/or AV motion) may be identified in response to an advertisement provided in the virtual world, and the feedback thereof may be provided to the UE and/or the AV or a customized advertisement may be provided.

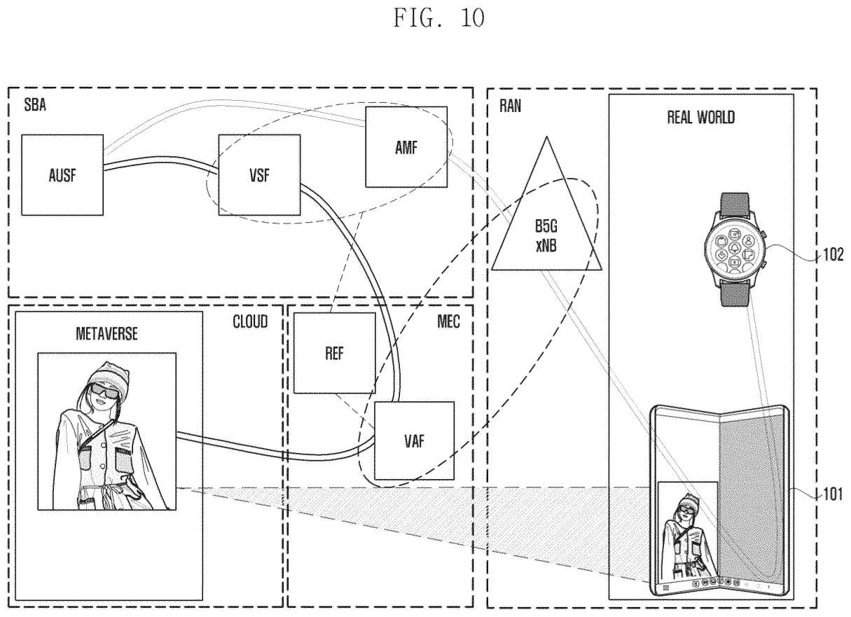

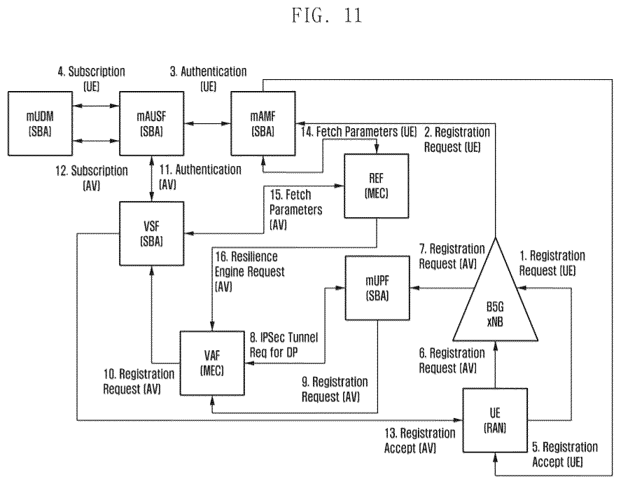

FIGS. 10 and 11 illustrate an example of a method of providing a virtual world service according to an embodiment.

According to an embodiment, the SBA may make a request for bounding the UE with the AV by using xNB of B5G and the mAMF. For example, the SBA may perform AV pre-arrangement through the mAMF. According to the AV pre-arrangement, authentication may be acquired from the mAUSF of the SBA. According to the AV pre-arrangement, subscription may be acquired from the mUDM of the SBA.

According to an embodiment, the SBA may make a request for bounding the UE with the AV by using xNB of B5G and the mUPF. For example, registration may be performed through the mUPF of the SBA according to UE post-arrangement. An IPSec tunnel may be configured between the mUPF of the SBA and the virtual application function (VAF) of the MEC, and the VAF of the MEC may make a request for registration to the VSF of the MEC. Authentication may be acquired from the mAUSF of the SBA according to the UE post-arrangement, and subscription may be acquired from the mUDM of the SBA according to the UE post-arrangement.

According to an embodiment, the MEC may make a request for searching for parameters for the UE and the AV by using the REF. In the case of the UE, a request may be transmitted to the mAMF of the SBA through B5G xNB. In the case of the AV, a request may be transmitted to the VSF through the mUPF of the SBA.

According to an embodiment, the MEC may infer attempted misbehavior by using UE and AV parameters acquired through the REF. With respect to significant symptoms of misbehavior, it is possible to communicate with the VAF of the MEC to take corrective action against the AV and acquire access through the mUPF and the B5G xNB to provide appropriate instructions to the AV.

Referring to FIG. 11, the registration request from the UE may be transferred to the mAMF through the B5G xNB, the mAMF may make a request for authenticating the UE to the mAUSF, and the mAUSF may make a request for subscribing to the UE to the mUDM. When registration is acquired from the mAMF, the UE may make a request for registering the AV to the mUPF through the B5G xNB, and the mUPF may make a request for configuring the IPsec tunnel and make a request for registering the AV through the VAF. The VAF may transfer the request for registering the AV to the VSF, the VSF may acquire authentication for the AV through the mAUSF and acquire subscription to the AV through the mUDM to notify the UE that registration of the AV has been completed. The REF may acquire the parameter of the UE through the mAMF and acquire the parameter of the AV through the VSF to send a request for control resilience for the AV to the VAF.

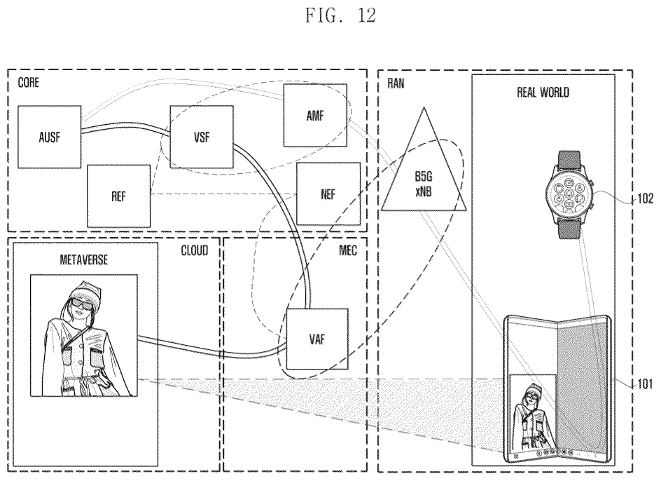

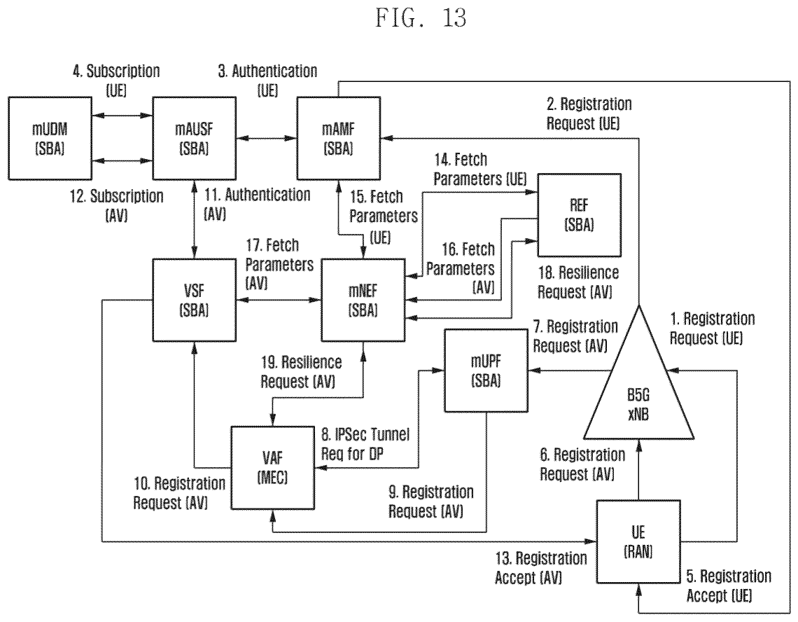

FIGS. 12 and 13 illustrate an example of a method of providing a virtual world service according to an embodiment.

According to an embodiment, the SBA may make a request for bounding the UE with the AV by using xNB of B5G and the mAMF. For example, AV pre-arrangement may be performed through the mAMF of the SBA. According to the AV pre-arrangement, authentication may be acquired from the mAUSF of the SBA. According to the AV pre-arrangement, subscription may be acquired from the mUDM of the SBA.

According to an embodiment, the SBA may make a request for bounding the UE with the AV by using xNB of B5G and the mUPF. For example, registration may be performed through the mUPF of the SBA according to UE post-arrangement. An IPSec tunnel may be configured between the mUPF of the SBA and the VAF of the MEC, and the VAF of the MEC may send a request for registration to the VSF of the MEC. Authentication may be acquired from the mAUSF of the SBA according to the UE post-arrangement, and subscription may be acquired from the mUDM of the SBA according to the UE post-arrangement.

According to an embodiment, the MEC may make a request for searching for parameters for the UE and the AV by using the REF. In the case of the UE, a search request may be transmitted to the mAMF and the mNEF of the SBA through B5G xNB. In the case of the AV, a search request may be transmitted to the VSF and the mNEF of the SBA through the mUPF of the SBA.

According to an embodiment, the MEC may infer attempted misbehavior by using UE and AV parameters acquired through the REF. With respect to significant symptoms of misbehavior, it is possible to communicate with the VAF of the MEC to take corrective action against the AV and acquire access through the mUPF and the B5G xNB to provide appropriate instructions to the AV. Referring to FIG. 13, the registration request from the UE may be transferred to the mAMF through the B5G xNB, the mAMF may make a request for authenticating the UE to the mAUSF, and the mAUSF may make a request for subscribing to the UE to the mUDM. When registration is acquired from the mAMF, the UE may make a request for registering the AV to the mUPF through the B5G xNB, and the mUPF may make a request for configuring the IPsec tunnel and make a request for registering the AV through the VAF. The VAF may transfer the request for registering the AV to the VSF, the VSF may acquire authentication for the AV through the mAUSF and acquire subscription to the AV through the mUDM to notify the UE that registration of the AV has been completed. The mNEF may acquire the parameter of the UE through the mAMF and acquire the parameter of the AV through the VSF, transfer the acquired parameters to the REF, and make a request for control resilience for the AV to the REF and the VAF.

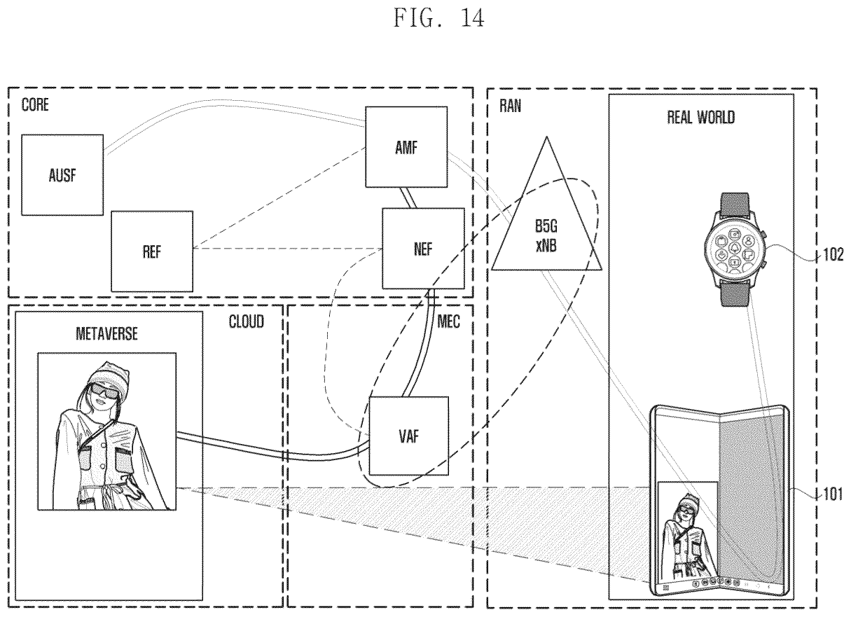

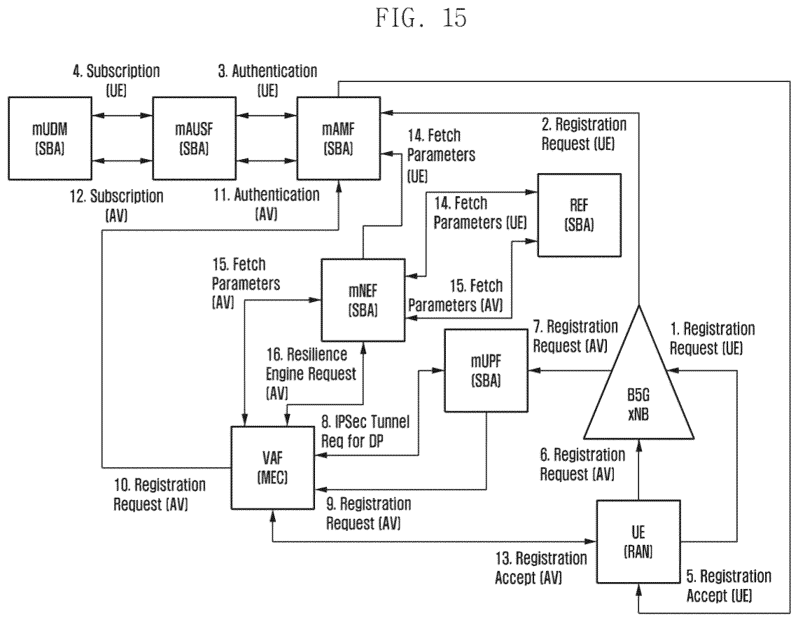

FIGS. 14 and 15 illustrates an example of a method of providing a virtual world service according to an embodiment.

According to an embodiment, the SBA may make a request for bounding the UE with the AV by using xNB of B5G and the mAMF. For example, AV pre-arrangement may be performed through the mAMF of the SBA. According to the AV pre-arrangement, authentication may be acquired from the mAUSF of the SBA. According to the AV pre-arrangement, subscription may be acquired from the mUDM of the SBA.

According to an embodiment, the SBA may make a request for bounding the UE with the AV by using xNB of B5G and the mUPF. For example, registration may be performed through the mUPF of the SBA according to UE post-arrangement. An IPSec tunnel may be configured between the mUPF of the SBA and the VAF of the MEC, and the VAF of the MEC may make a request for registration to the VSF of the MEC. Authentication may be acquired from the mAUSF of the SBA according to the UE post-arrangement, and subscription may be acquired from the mUDM of the SBA according to the UE post-arrangement.

According to an embodiment, the MEC may make a request for searching for parameters for the UE and the AV by using the REF. In the case of the UE, a search request may be transmitted to the mAMF and the mNEF of the SBA through B5G xNB. In the case of the AV, a search request may be transmitted to the VSF and the mNEF of the SBA through the mUPF of the SBA.

According to an embodiment, the MEC may infer attempted misbehavior by using UE and AV parameters acquired through the REF. With respect to significant symptoms of misbehavior, it is possible to communicate with the VAF of the MEC to take corrective action against the AV and acquire access through the mUPF and the B5G xNB to provide appropriate instructions to the AV.

Referring to FIG. 15, the registration request from the UE may be transferred to the mAMF through the B5G xNB, the mAMF may make a request for authenticating the UE to the mAUSF, and the mAUSF may make a request for subscribing to the UE to the mUDM. When registration is acquired from the mAMF, the UE may make a request for registering the AV to the mUPF through the B5G xNB, and the mUPF may make a request for configuring the IPsec tunnel and make a request for registering the AV through the VAF. The VAF may transfer the request for registering the AV to the mAMF, the mAMF may acquire authentication for the AV through the mAUSF and acquire subscription to the AV through the mUDM to notify the UE that registration of the AV has been completed. The mNEF may acquire the parameter of the UE through the mAMF and acquire the parameter of the AV through the VAF, transfer the acquired parameters to the REF, and make a request for control resilience for the AV to the VAF.

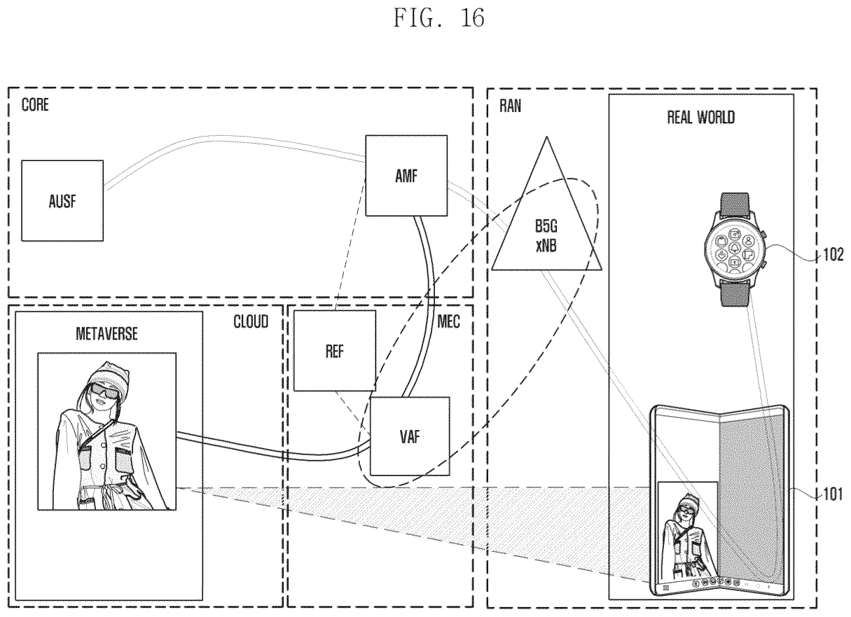

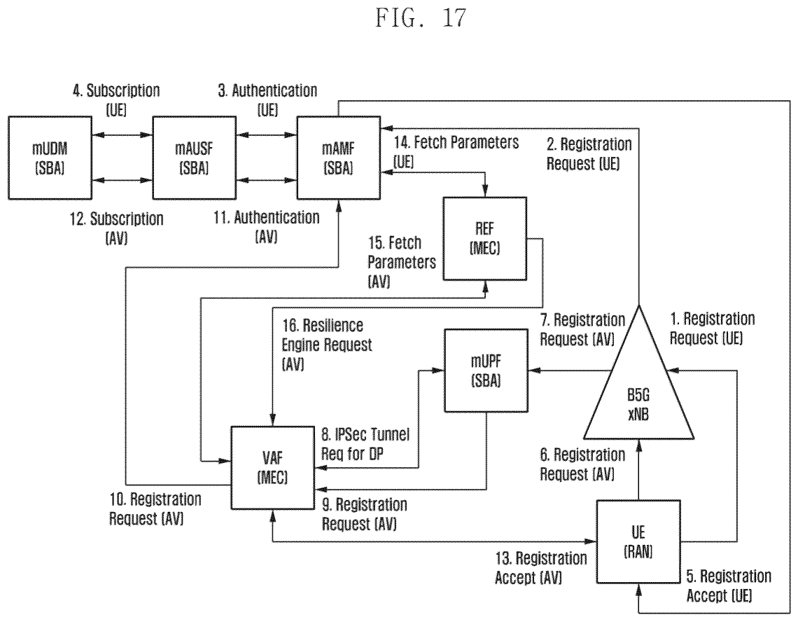

FIGS. 16 and 17 illustrate an example of a method of providing a virtual world service according to an embodiment.

According to an embodiment, the SBA may make a request for bounding the UE with the AV by using xNB of B5G and the mAMF. For example, the SBA may perform AV pre-arrangement through the mAMF. According to the AV pre-arrangement, authentication may be acquired from the mAUSF of the SBA. According to the AV pre-arrangement, subscription may be acquired from the mUDM of the SBA.

According to an embodiment, the SBA may make a request for bounding the UE with the AV by using xNB of B5G and the mUPF. For example, registration may be performed through the mUPF of the SBA according to UE post-arrangement. An IPSec tunnel may be configured between the mUPF of the SBA and the VAF of the MEC, and the VAF of the MEC may make a request for registration to the VSF of the MEC. Authentication may be acquired from the mAUSF of the SBA according to the UE post-arrangement, and subscription may be acquired from the mUDM of the SBA according to the UE post-arrangement.

According to an embodiment, the MEC may make a request for searching for parameters for the UE and the AV by using the REF. In the case of the UE, a request may be transmitted to the mAMF of the SBA through B5G xNB. In the case of the AV, a request may be transmitted to the VSF through the mUPF of the SBA.

According to an embodiment, the MEC may infer attempted misbehavior by using UE and AV parameters acquired through the REF. With respect to significant symptoms of misbehavior, it is possible to communicate with the VAF of the MEC to take corrective action against the AV and acquire access through the mUPF and the B5G xNB to provide appropriate instructions to the AV.

Referring to FIG. 17, the registration request from the UE may be transferred to the mAMF through the B5G xNB, the mAMF may make a request for authenticating the UE to the mAUSF, and the mAUSF may make a request for subscribing to the UE to the mUDM. When registration is acquired from the mAMF, the UE may make a request for registering the AV to the mUPF through the B5G xNB, and the mUPF may make a request for configuring the IPsec tunnel and make a request for registering the AV through the VAF. The VAF may transfer the request for registering the AV to the mAMF, the mAMF may acquire authentication for the AV through the mAUSF and acquire subscription to the AV through the mUDM to notify the UE that registration of the AV has been completed. The REF may acquire the parameter of the UE through the mAMF and acquire the parameter of the AV through the VAF to make a request for control resilience for the AV to the VAF.

Hereinafter, based on 5G or beyond 5G (B5G) and SBA, MEC, and Trino, a system for providing a virtual world service and a method of performing the virtual world service will be described.

The system for providing the virtual world service according to an embodiment may include an electronic device (for example, the electronic device 101 of FIG. 1 or 3) connected to an external electronic device (for example, the electronic device 102 of FIG. 1 or 3) and a server (for example, the server 108 of FIGS. 1 and 3) connected to the electronic device 101.

According to an embodiment, the system for providing the virtual world service may perform various functions or operations through various NFs in order to provide the virtual world service, based on 5G or beyond 5G (B5G), SBA, and the MEC architecture.

According to an embodiment, it is possible to improve a data acquisition function from the virtual world, for example, metaverse through a fast re-route (FRR) based on link failure protection by introducing an automated coordination function (ACF) to the B5G SBA.

According to an embodiment, it is possible to interaction with the ACF via the NEF through a co-ordination function (COF) located in Trino and to be mutually connected to a worker X function (WXF).

According to an embodiment, it is possible to perform conversion and operation of a virtual subscriber function (VSF) between the MEC and the SBA through the VSF.

According to an embodiment, the automated coordination function (ACF) may improve data acquisition through link failure protection based on the FRR. The virtual avatar function (VAF) may register the AV on behalf of the UE in the RAN. The coordination function (COF) may interact with the ACF and make a connection to the WXF. The worker X function (WXF) may physically or virtually instantiate a Trino worker. Modified user data management (mUDM) may register tandem including the UE and the AV corresponding thereto. The modified authentication server function (mAUSF) may perform an authentication process for the AV on behalf of the UE. The modified access and mobility management function (mAMF) may load the parameter of the UE and make authentication of the AV possible. The modified user plane function (mUPF) may perform AV registration through a DP/UP and translation between the DP/UP and the CP. The modified network exposure function (mNEF) may perform internal exposure and fetch parameters.

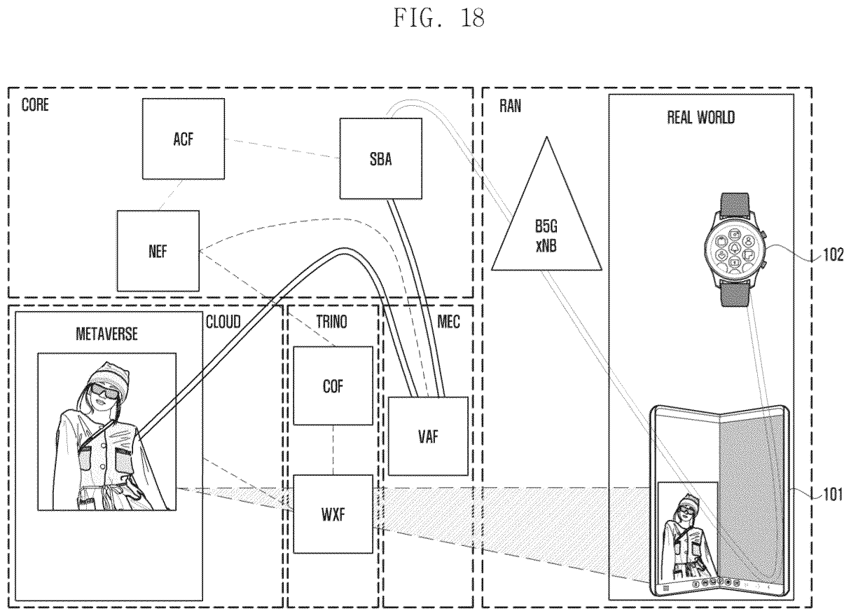

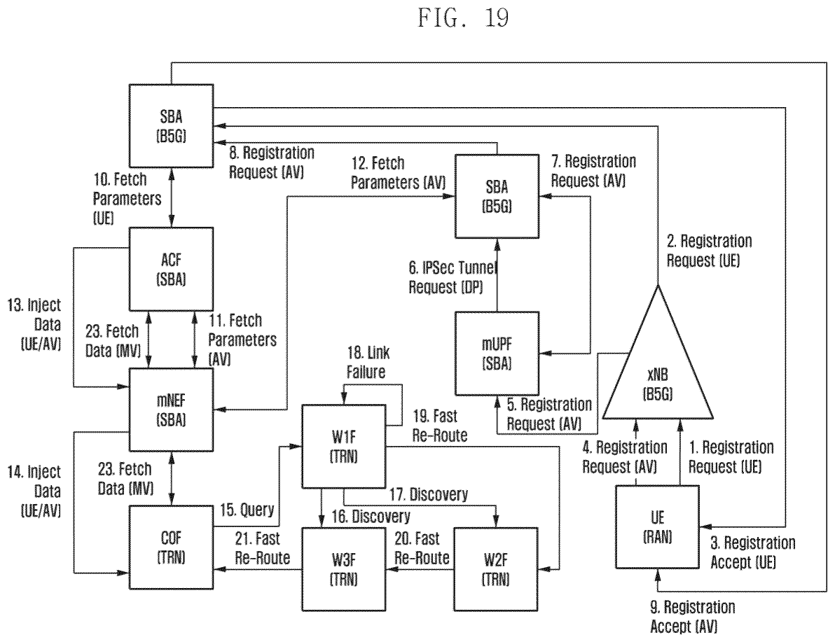

FIGS. 18 and 19 illustrates an example of a method of providing a virtual world service according to an embodiment.

According to an embodiment, the SBA may make a request for bounding the UE with the AV by using xNB of B5G and the mAMF. For example, the SBA may perform AV pre-arrangement through the mAMF. According to the AV pre-arrangement, authentication may be acquired from the mAUSF of the SBA. According to the AV pre-arrangement, subscription may be acquired from the mUDM of the SBA.

According to an embodiment, the SBA may make a request for bounding the UE with the AV by using xNB of B5G and the mUPF. For example, registration may be performed through the mUPF of the SBA according to UE post-arrangement. An IPSec tunnel may be configured between the mUPF of the SBA and the VAF of the MEC, and the VAF of the MEC may make a request for registration to the VSF of the MEC. Authentication may be acquired from the mAUSF of the SBA according to the UE post-arrangement, and subscription may be acquired from the mUDM of the SBA according to the UE post-arrangement.

According to an embodiment, a request for search for parameters for the UE, the AV, and the metaverse (MV) may be made using the ACF of the SBA. In the case of the UE, a request may be transmitted to the SBA through B5G xNB. In the case of the AV, a search request may be transmitted to the VAF of the MEC and the mNEF through the mUPF of the SBA. In the case of the MV, a search request may be transmitted to the COF of the Trino (TRN) and the mNEF through the WXF.

According to an embodiment, WXF failures or link failures between WXFs may be predicted using the COF of the TRN. Available WXFs may be discovered through recognition of MV parameters related to the UE and the MV. A proper alternative route may be obtained and virtual WXFs may be instantiated. The TRN may acquire MV parameters through the COF and the mNEF and execute the same in the WXF of the TRN.

Referring to FIG. 19, the registration request from the UE may be transferred to the SBA through the B5G xNB, and when registration is acquired from the SBA, the UE may make a request for registering the AV in the mUPF through the B5G xNB and the mUPF may make a request for configuring the IPsec tunnel to the VAF and make a request for registering the AV. The VAF may transfer the request for registering the AV to the SBA, and the SBA may notify the UE that the AV has been completely registered. The ACF may acquire the parameter of the UE through the SBA and acquire the parameter of the AV from the VAF through the mNEF. The ACF may transfer data of the UE and the AV to the COF through the mNEF, the COF may transmit a query to the W1F, the W1F may discover a W2F and a W3F, identify link failures, make a request for a fast re-route (FRR) to the W2F, and when the COF receives the request via the W3F, the COF may acquire data on the MV through the mNEF and the ACF.

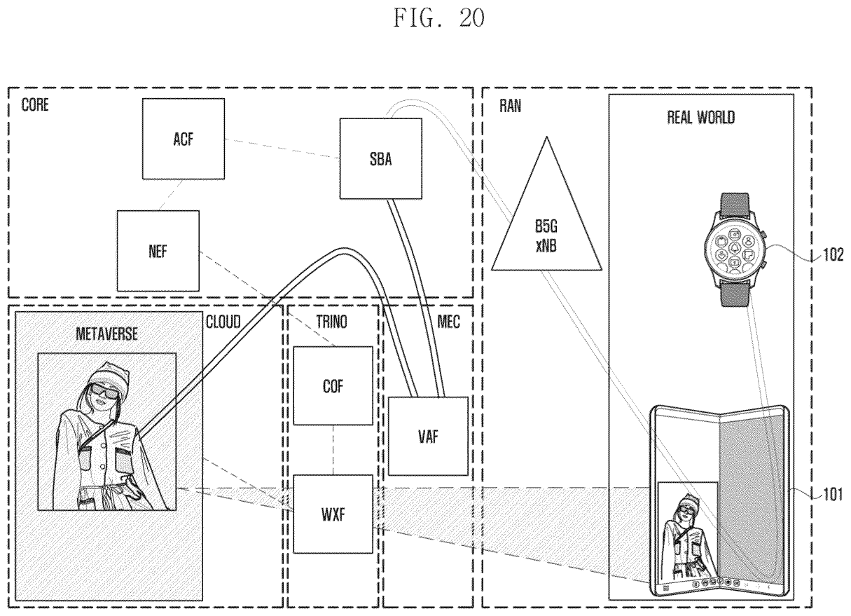

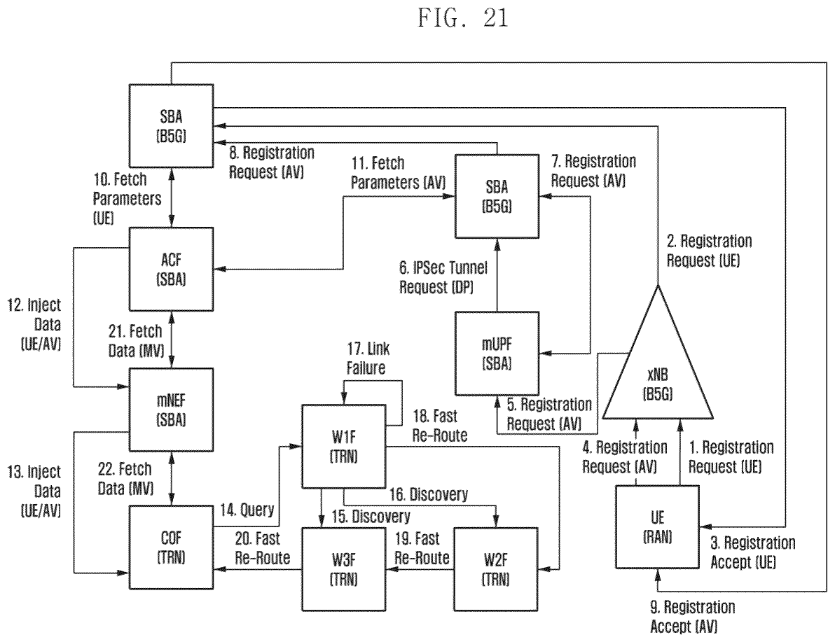

FIGS. 20 and 21 illustrate an example of a method of providing a virtual world service according to an embodiment.

According to an embodiment, the SBA may make a request for bounding the UE with the AV by using xNB of B5G and the mAMF. For example, the SBA may perform AV pre-arrangement through the mAMF. According to the AV pre-arrangement, authentication may be acquired from the mAUSF of the SBA. According to the AV pre-arrangement, subscription may be acquired from the mUDM of the SBA.

According to an embodiment, the SBA may make a request for bounding the UE with the AV by using xNB of B5G and the mUPF. For example, registration may be performed through the mUPF of the SBA according to UE post-arrangement. An IPSec tunnel may be configured between the mUPF of the SBA and the VAF of the MEC, and the VAF of the MEC may make a request for registration to the VSF of the MEC. Authentication may be acquired from the mAUSF of the SBA according to the UE post-arrangement, and subscription may be acquired from the mUDM of the SBA according to the UE post-arrangement.

According to an embodiment, a request for search for parameters for the UE, the AV, and the metaverse (MV) may be made using the ACF of the SBA. In the case of the UE, a request may be transmitted to the SBA through B5G xNB. In the case of the AV, a search request may be transmitted to the VAF of the MEC and the mNEF through the mUPF of the SBA. In the case of the MV, a search request may be transmitted to the COF of the TRN and the mNEF through the WXF of Trino (TRN).

According to an embodiment, WXF failures or link failures between WXFs may be predicted using the COF of the TRN. Available WXFs may be discovered through recognition of MV parameters related to the UE and the MV. A proper alternative route may be obtained and virtual WXFs may be instantiated. The TRN may acquire MV parameters through the COF and the mNEF and execute the same in the WXF of the TRN.

Referring to FIG. 21, the registration request from the UE may be transferred to the SBA through the B5G xNB, and when registration is acquired from the SBA, the UE may make a request for registering the AV in the mUPF through the B5G xNB and the mUPF may make a request for configuring the IPsec tunnel to the VAF and make a request for registering the AV. The VAF may transfer the request for registering the AV to the SBA, and the SBA may notify the UE that the AV has been completely registered. The ACF may acquire the parameter of the UE through the SBA and the parameter of the AV through the VAF, and transmit data of the UE and the AV to the mNEF to transfer the same to the COF, the COF may transmit a query to the WiF, the WiF may discover a W2F and a W3F, identify link failures, make a request for a fast re-route (FRR) to the W2F, and when the COF receives the request via the W3F, the COF may acquire data on the MV through the mNEF and the ACF.

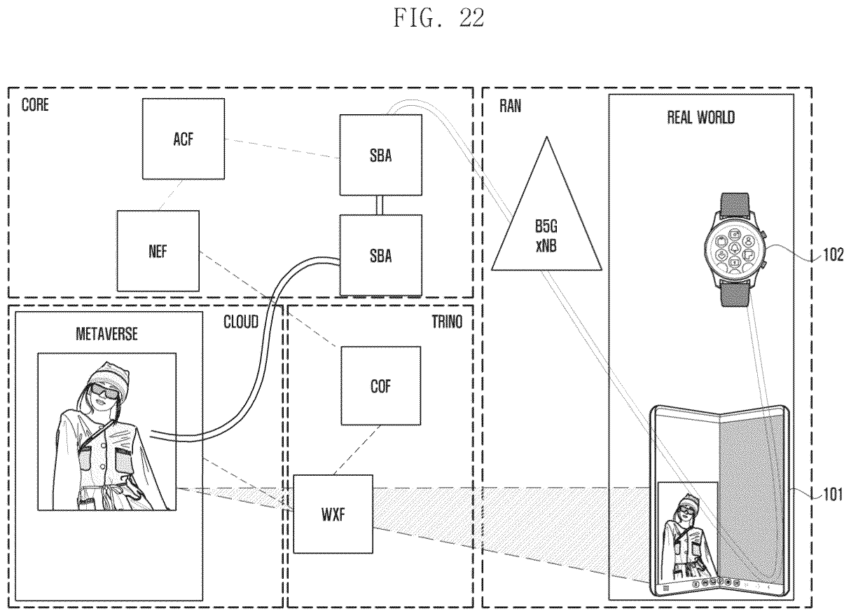

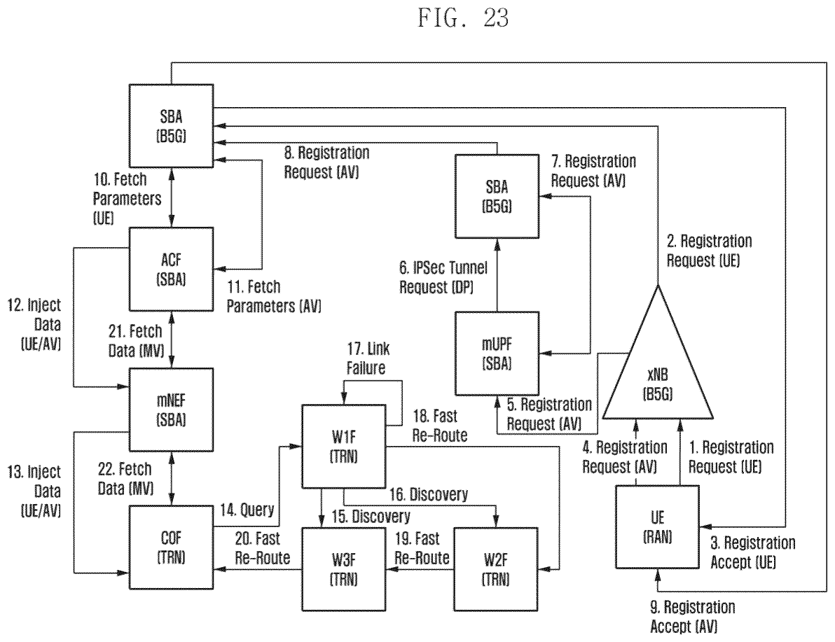

FIGS. 22 and 23 illustrate an example of a method of providing a virtual world service according to an embodiment.

According to an embodiment, the SBA may make a request for bounding the UE with the AV by using xNB of B5G and the mAMF. For example, the SBA may perform AV pre-arrangement through the mAMF. According to the AV pre-arrangement, authentication may be acquired from the mAUSF of the SBA. According to the AV pre-arrangement, subscription may be acquired from the mUDM of the SBA.

According to an embodiment, the SBA may make a request for bounding the UE with the AV by using xNB of B5G and the mUPF. For example, registration may be performed through the mUPF of the SBA according to UE post-arrangement. An IPSec tunnel may be configured between the mUPF of the SBA and the VAF of the MEC, and the VAF of the MEC may make a request for registration to the VSF of the MEC. Authentication may be acquired from the mAUSF of the SBA according to the UE post-arrangement, and subscription may be acquired from the mUDM of the SBA according to the UE post-arrangement.

According to an embodiment, a request for search for parameters for the UE, the AV, and the metaverse (MV) may be made using the ACF of the SBA. In the case of the UE, a request may be transmitted to the SBA through B5G xNB. In the case of the AV, a search request may be transmitted to the VAF of the MEC and the mNEF through the mUPF of the SBA. In the case of the MV, a search request may be transmitted to the COF of the TRN and the mNEF through the WXF of Trino (TRN).

According to an embodiment, WXF failures or link failures between WXFs may be predicted using the COF of the TRN. Available WXFs may be discovered through recognition of MV parameters related to the UE and the MV. A proper alternative route may be obtained and virtual WXFs may be instantiated. The TRN may acquire MV parameters through the COF and the mNEF and execute the same in the WXF of the TRN.

Referring to FIG. 23, the registration request from the UE may be transferred to the SBA through the B5G xNB, and when registration is acquired from the SBA, the UE may make a request for registering the AV in the mUPF through the B5G xNB and the mUPF may make a request for configuring the IPsec tunnel to the VAF and make a request for registering the AV. The VAF may transfer the request for registering the AV to the SBA, and the SBA may notify the UE that the AV has been completely registered. The ACF may acquire the parameter of the UE and the parameter of the AV through the SBA, and transmit data of the UE and the AV to the mNEF to transfer the same to the COF, the COF may transmit a query to the WiF, the W1F may discover a W2F and a W3F, identify link failures, make a request for a fast re-route (FRR) to the W2F, and when the COF receives the request via the W3F, the COF may acquire data on the MV through the mNEF and the ACF.

Hereinafter, based on 5G or beyond 5G (B5G), SBA, MEC, and Trino, a system for providing a virtual world service and a method of performing the virtual world service will be described.

The system for providing the virtual world service according to an embodiment may include an electronic device (for example, the electronic device 101 of FIG. 1 or 3) connected to an external electronic device (for example, the electronic device 102 of FIG. 1 or 3) and a server (for example, the server 108 of FIGS. 1 and 3) connected to the electronic device 101.

According to an embodiment, the system for providing the virtual world service may perform various functions or operations through various NFs in order to provide the virtual world service, based on 5G or beyond 5G (B5G), SBA, and the MEC architecture.

In the virtual world such as metaverse, unexpected behavior may occur in virtual objects such as avatars created by real users in the real world and implemented in the virtual world to represent the users. Accordingly, a circle of protection (COP) may be made. The COP may include a policy for predicting and responding to situations of abuse or harassment of avatars in metaverse.

According to an embodiment, data of the real world including various pieces of sensor data acquired from the external electronic device (for example, the electronic device 102 of FIG. 3) such as a smart watch may be provided to the virtual world such as metaverse.

According to an embodiment, it is possible to perform additional predictive analysis by acquiring data from the virtual word such as metaverse and synchronizing the data with real world data.

According to an embodiment, it is possible to propose a proper virtual advertisement by analyzing data and phenomena collected through the artificial intelligence function.

According to an embodiment, it is possible to introduce an advertisement service to the virtual world by introducing the artificial intelligence function (AIF) to the B5G SBA.

According to an embodiment, it is possible to apply artificial intelligence learning to data from the UE, the AV, and the MV by introducing the AIF to the B5G SBA.

According to an embodiment, it is possible to interaction with the ACF via the NEF through a co-ordination function (COF) located in Trino and make a mutual connection to a worker X function (WXF).

According to an embodiment, it is possible to make a direct mutual connection between the AIF and a virtual avatar function (VAF) through a virtual subscriber function (VSF) or an indirect mutual connection therebetween through the NEF.

According to an embodiment, by the AIF, it is possible to identify a circle of protection (COP)-based proposal advertisement view and identify instructions of the AV through the VAF and the MV through the VMF.

According to an embodiment, it is possible to apply artificial intelligence learning to data from the UE, the AV, and the MV by introducing the AIF. The virtual avatar function (VAF) may register the AV on behalf of the UE in the RAN. The coordination function (COF) may interact with the ACF and make a connection to the WXF. The worker X function (WXF) may physically or virtually instantiate a Trino worker. Modified user data management (mUDM) may register tandem including the UE and the AV corresponding thereto. A modified authentication server function (mAUSF) may perform an authentication process for the AV on behalf of the UE. A modified access and mobility management function (mAMF) may fetch the parameter of the UE and make authentication of the AV possible. A modified user plane function (mUPF) may perform AV registration through a DP/UP and translation between the DP/UP and the CP. A modified network exposure function (mNEF) may perform internal exposure and fetch the parameter.

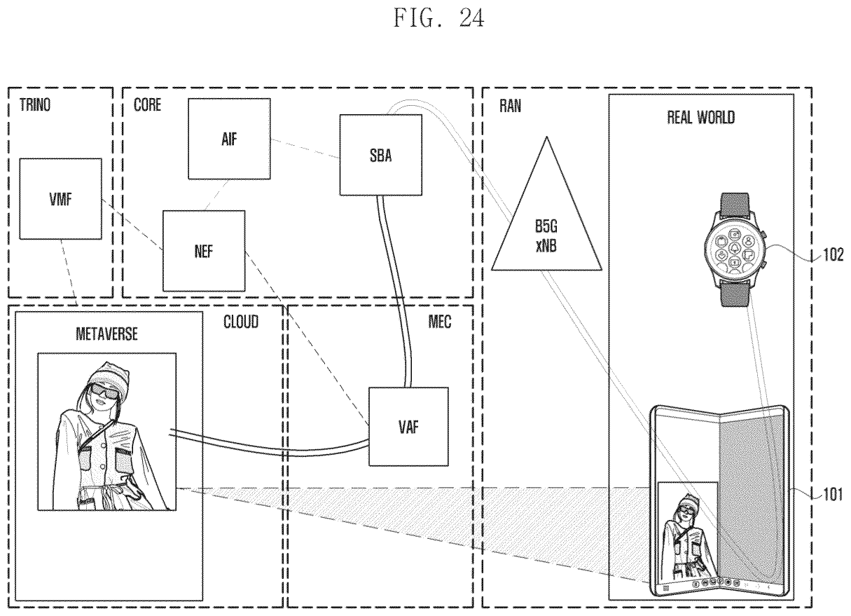

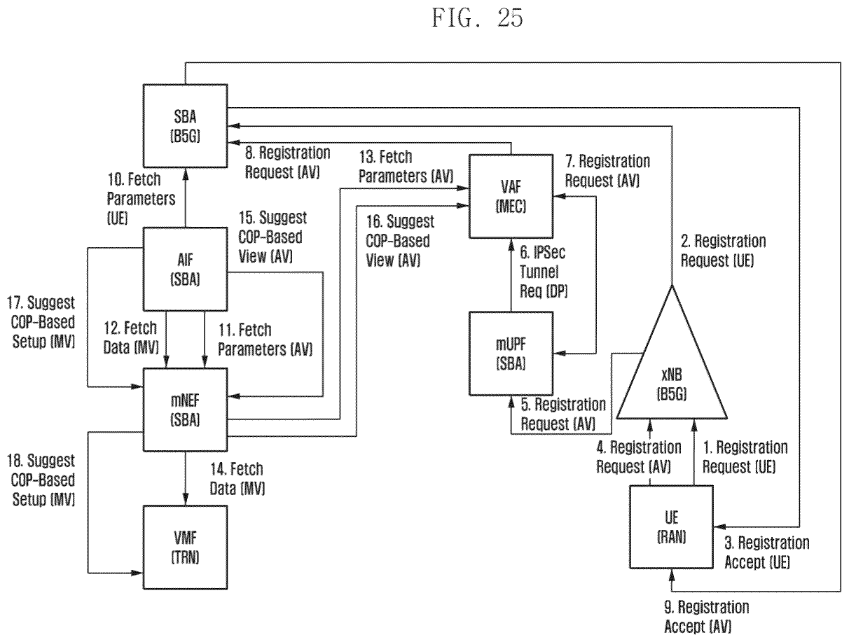

FIGS. 24 and 25 illustrates an example of a method of providing a virtual world service according to an embodiment.

According to an embodiment, the SBA may make a request for bounding the UE with the AV using xNB of B5G and the mAMF. For example, the SBA may perform AV pre-arrangement through the mAMF. According to the AV pre-arrangement, authentication may be acquired from the mAUSF of the SBA. According to the AV pre-arrangement, subscription may be acquired from the mUDM of the SBA.

According to an embodiment, a request for bounding the UE with the AV may be made using xNB of B5G and the mUPF. For example, registration may be performed through the mUPF of the SBA according to UE post-arrangement. An IPSec tunnel may be configured between the mUPF of the SBA and the VAF of the MEC, and the VAF of the MEC may make a request for registration to the VSF of the MEC. Authentication may be acquired from the mAUSF of the SBA according to the UE post-arrangement, and subscription may be acquired from the mUDM of the SBA according to the UE post-arrangement.

According to an embodiment, a request for search for parameters for the UE, the AV, and metaverse (MV) may be made using the AIF of the SBA. In the case of the UE, a request may be transmitted to the SBA through B5G xNB. In the case of the AV, a search request may be transmitted to the VAF of the MEC and the mNEF through the AIF of the SBA. In the case of the MV, a search request may be transmitted to the COF of the TRN and the mNEF through the WXF of Trino (TRN).

According to an embodiment, based on data acquired from the UE, the AV, and the MV, a COP-based view for the AV may be proposed through the VAF of the MEC by using the mNEF through a machine-learned model that is continuously AIF embedded-trained, and a COP-based view may be proposed to the MV through the VMP of the TRN.

Referring to FIG. 25, the registration request from the UE may be transferred to the SBA through the B5G xNB, and when registration is acquired from the SBA, the UE may make a request for registering the AV to the mUPF through the B5G xNB and the mUPF may make a request for configuring the IPsec tunnel to the VAF and make a request for registering the AV. The VAF may transfer the request for registering the AV to the SBA, and the SBA may notify the UE that the AV has been completely registered. The AIF may acquire the parameter for the UE through the SBA, acquire the parameter for the AV from the VAF through the mNEF, acquire data of the MV from the VMF through the mNEF, transmit the COP-based view proposal for the AV to the mNEF to transfer the same to the VAF, and transmit the COP-based configuration proposal for the MV to the VMF through the mNEF.

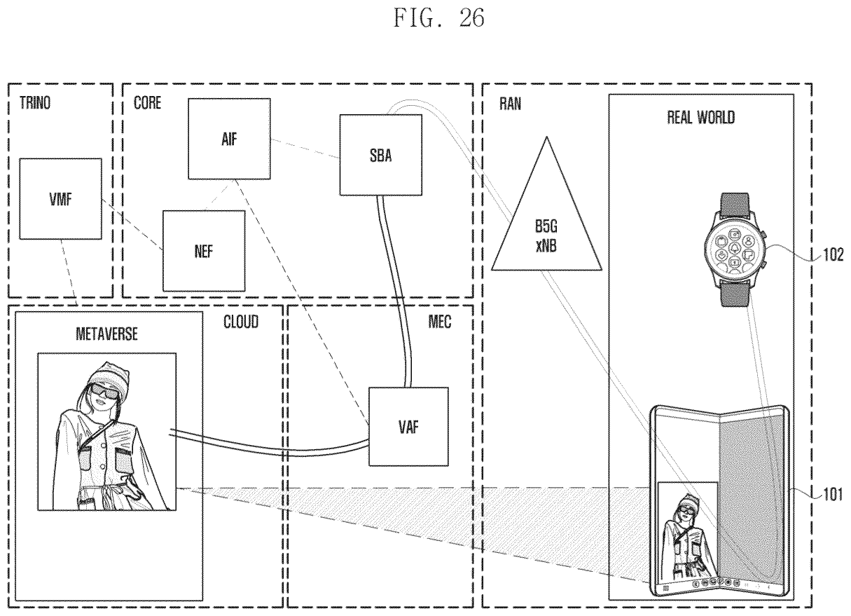

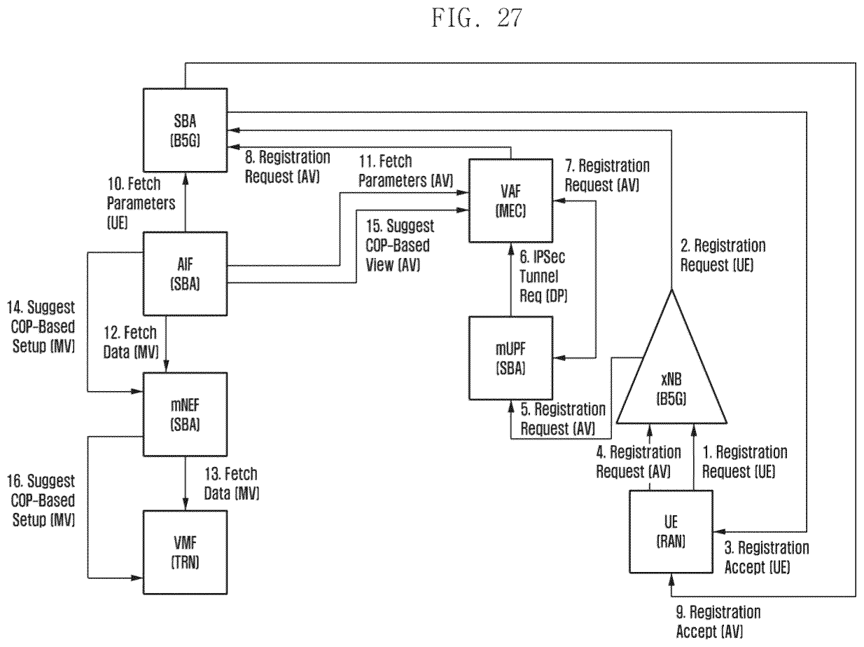

FIGS. 26 and 27 illustrate an example of a method of providing a virtual world service according to an embodiment.

According to an embodiment, the SBA may make a request for bounding the UE with the AV by using xNB of B5G and the mAMF. For example, the SBA may perform AV pre-arrangement through the mAMF. According to the AV pre-arrangement, authentication may be acquired from the mAUSF of the SBA. According to the AV pre-arrangement, subscription may be acquired from the mUDM of the SBA.

According to an embodiment, a request for bounding the UE with the AV may be made using xNB of B5G and the mUPF. For example, registration may be performed through the mUPF of the SBA according to UE post-arrangement. An IPSec tunnel may be configured between the mUPF of the SBA and the VAF of the MEC, and the VAF of the MEC may make a request for registration to the VSF of the MEC. Authentication may be acquired from the mAUSF of the SBA according to the UE post-arrangement, and subscription may be acquired from the mUDM of the SBA according to the UE post-arrangement.

According to an embodiment, a request for search for parameters for the UE, the AV, and metaverse (MV) may be made using the AIF of the SBA. In the case of the UE, a request may be transmitted to the SBA through B5G xNB. In the case of the AV, a search request may be transmitted to the VAF of the MEC and the mNEF through the AIF of the SBA. In the case of the MV, a search request may be transmitted to the COF of the TRN and the mNEF through the WXF of Trino (TRN).

According to an embodiment, based on data acquired from the UE, the AV, and the MV, a COP-based view for the AV may be proposed through the VAF of the MEC by using the mNEF through a machine-learned model that is continuously AIF embedded-trained, and a COP-based view may be proposed to the MV through the VMP of the TRN.

Referring to FIG. 27, the registration request from the UE may be transferred to the SBA through the B5G xNB, and when registration is acquired from the SBA, the UE may make a request for registering the AV in the mUPF through the B5G xNB and the mUPF may make a request for configuring the IPsec tunnel to the VAF and make a request for registering the AV. The VAF may transfer the request for registering the AV to the SBA, and the SBA may notify the UE that the AV has been completely registered. The AIF may acquire the parameter of the UE through the SBA, acquire the parameter of the AV from the VAF, acquire data of the MV from the VMF through the mNEF, and transmit the COP-based configuration proposal for the MV to the VMF through the mNEF.

According to an embodiment, a method of providing a virtual world service may include: an operation of receiving, by a SBA, a first registration request from a user equipment (UE); an operation of receiving, by the SBA, a second registration request for a virtual object related to the UE through a virtual application function (VAF) in a virtual world based on whether the first registration request is allowed; an operation of acquiring parameters for the UE, the virtual object, and the virtual world by an artificial intelligence function (AIF); and an operation of providing a virtual mesh function (VMF) with information configured for the virtual world by the AIF.

According to an embodiment, the method may further include an operation of receiving the registration request for the virtual object from the UE through a virtual avatar function (VAF), by the SBA.

According to an embodiment, the VAF may be configured to receive the registration request for the virtual object from the UE through a modified user plane function (mUPF).

According to an embodiment, the VAF may be configured to receive the registration request for the virtual object through an IPSec tunnel configured between the VAF and the mUPF.

According to an embodiment, the method may further include an operation of receiving the registration request for the virtual object from the UE and transferring an IPSec tunnel request to the VAF, by the mUPF.

According to an embodiment, the method may further include an operation of sending a request for the parameter for the UE to the SBA by the AIF.

According to an embodiment, the method may further include an operation of sending a request for the parameter for the virtual object to the VAF, by the AIF.

According to an embodiment, the method may further include an operation of sending a request for the parameter for the virtual world to the VMF through a modified network exposure function (mNEF), by the AIF.

According to an embodiment, the method may further include an operation of providing the VAF with the configured information through a modified network exposure function (mNEF), by the AIF.

According to an embodiment, the method may further include an operation of sending a request for the parameter for the virtual object to the VAF through a modified network exposure function (mNEF), by the AIF.

According to an embodiment, a system for providing a virtual world service may include a SBA configured to receive a first registration request from a user equipment (UE), a virtual application function (VAF) configured to transmit a second registration request for a virtual object related to the UE from the UE to the SBA in a virtual world based on whether the first registration request is allowed, an artificial intelligence function (AIF) configured to acquire parameters for the UE, the virtual object, and the virtual world, and a virtual mesh function (VMF) configured to receive information configured for the virtual world by the AIF.

According to an embodiment, the system may further include a virtual avatar function (VAF) configured to transfer the registration request for the virtual object from the UE to the SBA.

According to an embodiment, the VAF may be configured to receive the registration request for the virtual object from the UE through a modified user plane function (mUPF).

According to an embodiment, the VAF may be configured to receive the registration request for the virtual object through an IPSec tunnel configured between the VAF and the mUPF.

According to an embodiment, the mUPF may be configured to receive the registration request for the virtual object from the UE and transfer an IPSec tunnel request to the VAF.

According to an embodiment, the AIF may be configured to make a request for the parameter for the UE to the SBA.

According to an embodiment, the AIF may be configured to make a request for the parameter for the virtual object to the VAF.

According to an embodiment, the AIF may be configured to make a request for the parameter for the virtual world to the VMF through a modified network exposure function (mNEF).

According to an embodiment, the AIF may be configured to provide with the configured information through a modified network exposure function (mNEF).

According to an embodiment, the AIF may be configured to make a request for the parameter for the virtual object to the VAF through a modified network exposure function (mNEF).

Embodiments disclosed in this document are presented only for examples for easily describing the technical content and assisting understanding, and do not limit the scope of the technology disclosed in this document. Accordingly, the scope of the technology disclosed in this document should be construed to including all changes or modified forms derived on the basis of the technical idea of various embodiments of the disclosure as well as the embodiments disclosed herein.

What is claimed is:

1. A method of providing a virtual world service, the method comprising:
receiving, by a service-based architecture (SBA), a first registration request from a user equipment (UE);
receiving, by the SBA, a second registration request for a virtual object related to the UE through a virtual application function (VAF) in a virtual world, based on whether the first registration request is allowed;
acquiring parameters for the UE, the virtual object, and the virtual world by an artificial intelligence function (AIF); and
providing a virtual mesh function (VMF) with information configured for the virtual world by the AIF.

2. The method of claim 1, further comprising receiving, by the SBA, the second registration request for the virtual object from the UE through a virtual avatar function.

3. The method of claim 2, further comprising receiving, by the virtual avatar function, the second registration request for the virtual object from the UE through a modified user plane function (mUPF).

4. The method of claim 3, further comprising receiving, by the virtual avatar function, the second registration request for the virtual object through an IPSec tunnel configured between the virtual avatar function and the mUPF.

5. The method of claim 4, further comprising:
receiving, by the mUPF, the second registration request for the virtual object from the UE, and
transferring an IPSec tunnel request to the virtual avatar function.

6. The method of claim 1, further comprising sending, to the SBA by the AIF, a first request for a first parameter for the UE.

7. The method of claim 6, further comprising sending, to the VAF, by the AIF, a second request for a second parameter for the virtual object.

8. The method of claim 1, further comprising sending, by the AIF, a request for a parameter for the virtual world to the VMF through a modified network exposure function (mNEF).

9. The method of claim 1, further comprising providing the VAF with the information through a modified network exposure function (mNEF), by the AIF.

10. The method of claim 1, further comprising sending, by the AIF, a request for a parameter for the virtual object to the VAF through a modified network exposure function (mNEF).

11. A system for providing a virtual world service, the system comprising:
a service-based architecture (SBA) configured to receive a first registration request from a user equipment (UE);
a virtual application function (VAF) configured to transmit a second registration request for a virtual object related to the UE from the UE to the SBA in a virtual world, based on whether the first registration request is allowed;
an artificial intelligence function (AIF) configured to acquire parameters for the UE, the virtual object, and the virtual world; and
a virtual mesh function (VMF) configured to receive information configured for the virtual world by the AIF.

12. The system of claim 11, further comprising a virtual avatar function configured to transfer, from the UE to the SBA, the second registration request for the virtual object.

13. The system of claim 12, wherein the virtual avatar function is configured to receive, from the UE through a modified user plane function (mUPF), the second registration request for the virtual object.

14. The system of claim 13, wherein the virtual avatar function is configured to receive the second registration request for the virtual object through an IPSec tunnel configured between the VAF and the mUPF.

15. The system of claim 14, wherein the mUPF is configured to:
receive, from the UE, the second registration request for the virtual object, and
transfer an IPSec tunnel request to the VAF.

16. The system of claim 11, wherein the AIF is configured to send, to the SBA, a first request for a first parameter for the UE.

17. The system of claim 16, wherein the AIF is configured to send, to the VAF, a second request for a second parameter for the virtual object.

18. The system of claim 11, wherein the AIF is configured to send a request for a parameter for the virtual world to the VMF through a modified network exposure function (mNEF).

19. The system of claim 11, wherein the AIF is configured to provide the VAF with the information through a modified network exposure function (mNEF).

20. The system of claim 11, wherein the AIF is configured to send a request for a parameter for the virtual object to the VAF through a modified network exposure function (mNEF).
